(19) United States
(12) Patent Application Publication
(10) Pub. No.: US 2016/0140194 A1
(43) Pub. Date: May 19, 2016

(54) DATA MIGRATION SYSTEM AND DATA MIGRATION METHOD THEREOF

(71) Applicant: BIGTERA LIMITED, Hong Kong (CN)

(72) Inventors: Cheng-Yue CHANG, Taipei City (TW); Jian-Ying CHEN, Taipei City (TW); Yung-Hua CHU, Taipei City (TW); Kuan-Kai CHIU, Taipei City (TW); Po-Hsun YEN, Taipei City (TW); Tsung-Lin YU, Taipei City (TW); Ming-Xun ZHONG, Taipei City (TW)

(21) Appl. No.: 14/540,928

(22) Filed: Nov. 13, 2014

(51) Int. Cl. G06F 17/30; H04L 29/08

(52) U.S. Cl. CPC G06F 17/30557; H04L 67/1097

(57) ABSTRACT

A data migration system and a data migration method thereof are provided. The data migration system comprises a transmission unit, a storage unit and a processing unit. The transmission unit is configured to connect with a client and a legacy storage system. The processing unit is configured to: receive a first data request from the client via the transmission unit, wherein the first data request indicates a required data; determine that the required data is missed in the storage unit; retrieve the required data from the legacy storage system via the transmission unit; copy the required data in the storage unit; and transmit the required data to the client via the transmission unit.

### CROSS-REFERENCES TO RELATED APPLICATIONS

Not applicable.

### BACKGROUND OF THE INVENTION

1. Field of the Invention

The present invention relates to a data migration system and a data migration method thereof; and more particularly, the present invention relates to seamless data migration system and data migration method thereof.

2. Descriptions of the Related Art

As the user demand and the efficiency for accessing the network system raise continuously, high quality server hardware develops correspondingly. Specifically, the storage equipment plays a big role in the network system since the operating speed of the storage equipment relates to the data accessing speed of the network system directly. Accordingly, the network service providers need to regularly update the storage equipment of the network system to fulfill the user requirements, and data migrations are needed while renewing the storage equipment.

However, in the prior art, there are some serious problems while migrating the data from the old storage equipment to the new one. Particularly, the service of the network system will be suspended during the process of the data migration since the validities of the data are important while the data is migrated, and the amount of the suspending time depends on the speed of the process of the data migration. Hence, it is inconvenient for the user during the data migration. Moreover, data losses could be happened during the process of the data migration if the migrating operation is not appropriate.

Accordingly, it is important to overcome the shortcomings of the conventional data migration to make the network system provide the service more stable and more flexible.

### SUMMARY OF THE INVENTION

The primary objective of this invention is to provide a data migration method for use in a data migration system. The data migration system is connected to a client and a legacy storage system. The data migration method comprises the following steps: (a) receiving, by the data migration system, a first data request from the client, wherein the first data request indicates a required data; (b) determining, by the data migration system, that the required data is missed in the data migration system; (c) retrieving, by the data migration system, the required data from the legacy storage system; (d) copying, by the data migration system, the required data in the data migration system; (e) transmitting, by the data migration system, the required data to the client.

Another objective of this invention is to provide a data migration system which comprises a transmission unit, a storage unit and a processing unit. The transmission unit is configured to connect with a client and a legacy storage system. The processing unit is configured to: receive a first data request from the client via the transmission unit, wherein the first data request indicates a required data; determine that the required data is missed in the storage unit; retrieve the required data from the legacy storage system via the transmission unit; copy the required data in the storage unit; and transmit the required data to the client via the transmission unit.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of network environment of the data migration system according to the first embodiment of the present invention;

FIG. 1B is a schematic view of the data migration system according to the first embodiment of the present invention;

FIG. 2 is a schematic view of network environment of a data migration system according to the second embodiment of the present invention; and

FIGS. 3A-3B are flowchart diagrams of the data migration method according to the third embodiment of the present invention;

### DESCRIPTION OF THE PREFERRED EMBODIMENT

In the following descriptions, the present invention will be explained with reference to embodiments thereof. However, these embodiments are not intended to limit the present invention to any specific environment, applications or particular implementations described in these embodiments. Therefore, the description of these embodiments is only for the purpose of illustration rather than limitation. It shall be appreciated that in the following embodiments and the attached drawings, elements not directly related to the present invention are omitted from depiction.

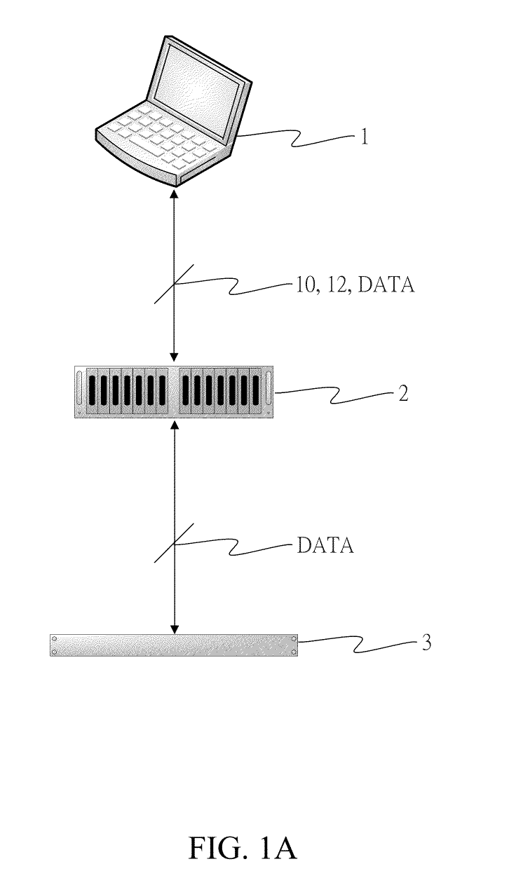

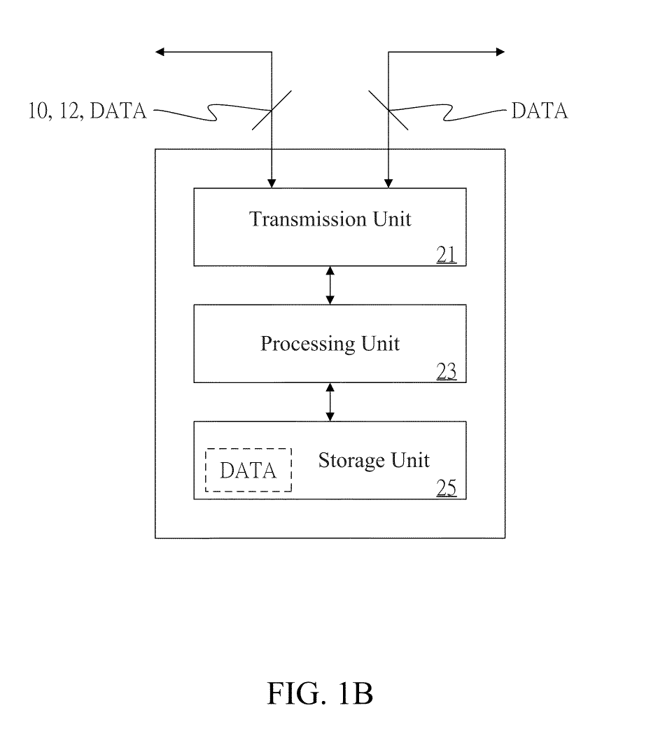

Please refer to FIGS. 1A and 1B. FIG. 1A is a schematic view of network environment of a data migration system 2 according to a first embodiment of the present invention. FIG. 1B is a schematic view of the data migration system 2 according to the first embodiment of the present invention. The data migration system 2 comprises a transmission unit 21, a processing unit 23 and a storage unit 25. The transmission unit 21, the processing unit 23 and the storage unit 25 connect to each other electrically. Interactions between the apparatuses will be further described hereinafter.

First, when the data of a legacy storage system 3 is going to be migrated to the data migration system 2, the data migration system 2 is then allocated between a client 1 and the legacy storage system 3 and the transmission unit 21 connects with the client 1 and the legacy storage system 3. Then, when the client 1 requests data from the legacy storage system 3, it transmits a first data request 10, which indicates a required data DATA, to the legacy storage system 3.

Afterwards, since the data migration system 2 is allocated between the client 1 and the legacy storage system 3, the first data request 10 will pass through the data migration system 2 first. Accordingly, the processing unit 23 is capable of receiving the first data request 10 via the transmission unit 21. Then, the processing unit 23 determines that the required data DATA is missed in the storage unit 25 since the required data DATA has not been migrated from the legacy storage system 3 before.

Accordingly, the processing unit 23 retrieves the required data DATA from the legacy storage system 3 via the transmission unit 21 according to the first data request 10. Then the processing unit 23 copies the required data DATA in the storage unit 25. Final, the processing unit 21 transmits the required data DATA to the client 1 via the transmission unit 21 to fulfill the requirement of the client 1. Optionally, the processing unit 23 can be configured to delete the required data DATA in the legacy storage system 3 after the required data DATA is copied in the storage unit 25.

It should be noted that, in other embodiments, the storage unit 25 can further stores a data transferring status table (not shown). The data transferring status table records data transferring status (if the data is copied from the legacy storage system 3 to the data migration system 2 or not) between the data migration system 2 and the legacy storage system 3 so that the processing unit 21 can determine whether the required data DATA is missed in the data migration system 2.

Accordingly, the processing unit 23 can further record that the required data DATA is stored in the storage unit 25 in the data transferring status table for later judgments. However, it is not to limit the implementations of recoding the migration status of data. The people skilled in this art should easily think other modifications for recording the migration status of data based on the disclosures of the present application.

Next, when the client 1 requests the required data DATA from the legacy storage system 3 again, it transmits a second data request 12 to the legacy storage system 3. Similarly, the second data request 12 will pass through the data migration system 2 first. Accordingly, the processing unit 23 is capable of receiving the second data request 12 via the transmission unit 21.

Then, the processing unit 23 determines (e.g., based on the data transferring status table) that the required data DATA is stored in the storage unit 25 since the required data DATA has been copied from the legacy storage system 3 before. Therefore, the processing unit 23 transmits the required data DATA to the client 1 via the transmission unit 21 directly.

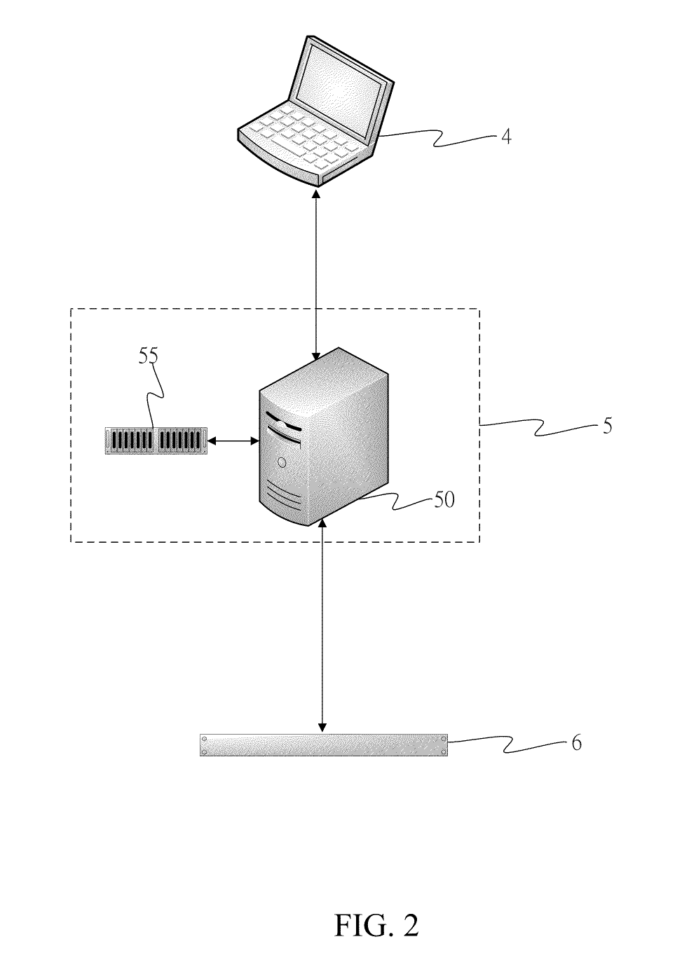

It should be stressed that the storage unit of the data migration system of the present invention can be set independently. Please refer to FIG. 2, which is a schematic view of network environment of a data migration system 5 according to a second embodiment of the present invention. Specifically, a server element 50 (which comprises a transmission unit and a processing unit) of the data migration system 5 connects with a client 4 and a legacy storage system 6, and a storage unit 55 is not combined with the server element 50 physically. However, the storage unit 55 is still one element of the data migration system 5.

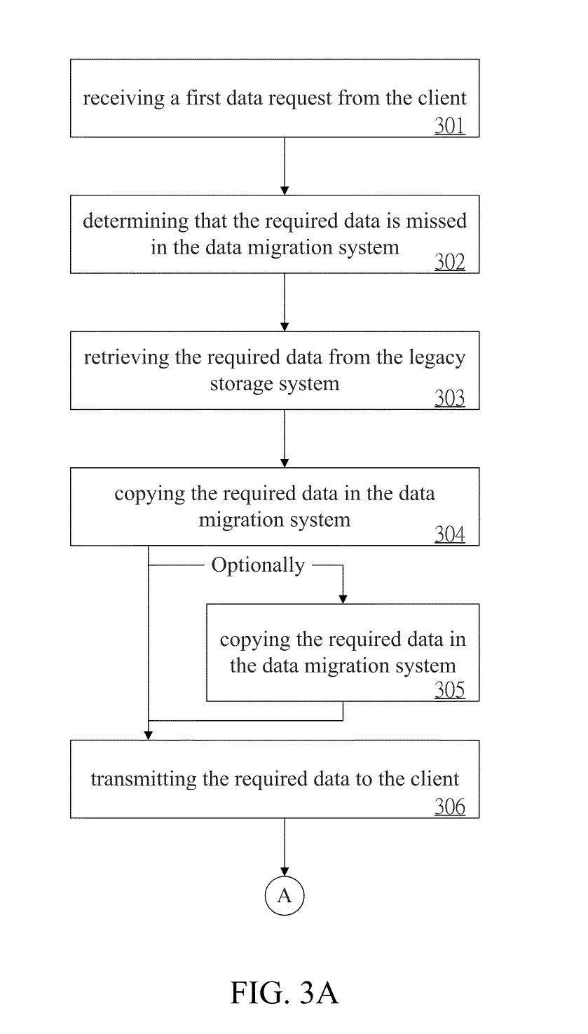

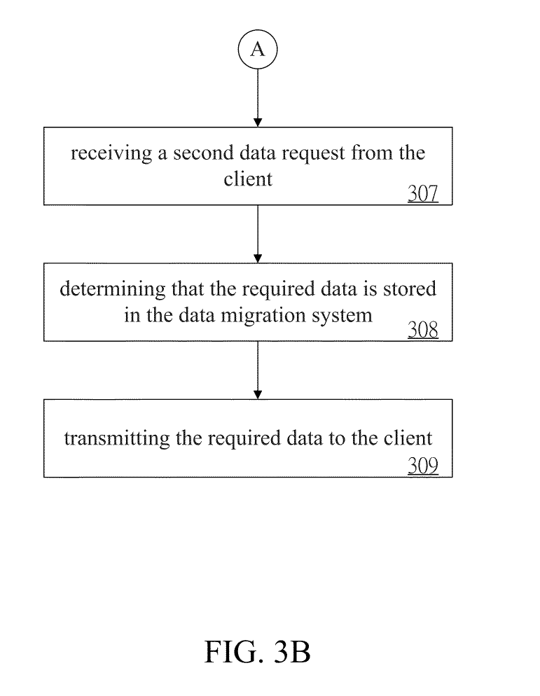

A third embodiment of the present invention is a data migration method, a flowchart diagram of which is shown in FIGS. 3A and 3B. The method of the third embodiment is used in a data migration system (e.g., the data migration system 2 of the aforesaid embodiments). The data migration system is connected to a client and a legacy storage system. The steps of the third embodiment are detailed as follows.

Firstly, a step 301 is executed to receive, by the data migration system, a first data request from the client. The first data request indicates a required data stored in the legacy storage system. Step 302 is executed to determine, by the data migration system, that the required data is missed in the data migration system. Step 303 is executed to retrieve, by the data migration system, the required data from the legacy storage system.

Then, step 304 is executed to copy, by the data migration system, the required data in the data migration system. It should be noted that step 305 is optionally executed to delete, by the data migration system, the required data in the legacy storage system. Step 306 is executed to transmit, by the data migration system, the required data to the client.

Similarly, a data transferring status table which records data transferring status between the data migration system and the legacy storage system can be used for the data migration system to determine that the required data is missed in the data migration system. The required data being stored in the migration system can be recorded after step 304. However, it is not to limit the implementations of recoding the migration status of data.

Afterwards, step 307 is executed to receive, by the data migration system, a second data request from the client. The second data request indicates the required data as well. Step 308 is executed to determine, by the data migration system, that the required data is stored in the data migration system (e.g., based on the data transferring status table). Finally, step 309 is executed to transmit, by the data migration system, the required data to the client.

According to the above descriptions, the data migration system and the data migration method thereof according to the present invention can migrate the data from old storage to a new one without suspending the system so that the accessing service is provided continuously, safely, stably and completely during the migration process.

The above disclosure is related to the detailed technical contents and inventive features thereof People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A data migration method for use in a data migration system, the data migration system being connected to a client and a legacy storage system, the data migration method comprising:
(a) receiving, by the data migration system, a first data request from the client, wherein the first data request indicates a required data;
(b) determining, by the data migration system, that the required data is missed in the data migration system;
(c) retrieving, by the data migration system, the required data from the legacy storage system;
(d) copying, by the data migration system, the required data in the data migration system;
(e) transmitting, by the data migration system, the required data to the client.

2. The data migration method as claimed in claim 1, wherein the data migration system determines that the required data is missed in the data migration system based on a data transferring status table which records data transferring status between the data migration system and the legacy storage system.

3. The data migration method as claimed in claim 2, further comprising the following step after step (d):
(d1) recording, by the data migration system, that the required data is stored in the migration system in the data transferring status table.

4. The data migration method as claimed in claim 3, further comprising:
(f) receiving, by the data migration system, a second data request from the client, wherein the second data request indicates the required data;
(g) determining, by the data migration system, that the required data is stored in the data migration system based on the data transferring status table;
(h) transmitting, by the data migration system, the required data to the client.

5. The data migration method as claimed in claim 1, further comprising the following step after step (d):
(f) deleting, by the data migration system, the required data in the legacy storage system.

6. A data migration system, comprising:
a transmission unit, being configured to connect with a client and a legacy storage system;
a storage unit; and
a processing unit, being configured to:
receive a first data request from the client via the transmission unit, wherein the first data request indicates a required data;
determine that the required data is missed in the storage unit;
retrieve the required data from the legacy storage system via the transmission unit;
copy the required data in the storage unit;
transmit the required data to the client via the transmission unit.

7. The data migration system as claimed in claim 6, wherein the storage unit further stores a data transferring status table which records data transferring status between the data migration system and the legacy storage system, and the processing unit determines that the required data is missed in the storage unit based on the data transferring status table.

8. The data migration system as claimed in claim 7, wherein the processing unit is further configured to record that the required data is stored in the storage unit in the data transferring status table.

9. The data migration system as claimed in claim 8, wherein the processing unit is further configured to:
receive a second data request from the client via the transmission unit, wherein the second data request indicates the required data;
determine that the required data is stored in the storage unit based on the data transferring status table;
transmit the required data to the client via the transmission unit.

10. The data migration system as claimed in claim 6, wherein the processing unit is further configured to delete the required data in the legacy storage system.
